(19) United States
(12) Patent Application Publication
(10) Pub. No.: US 2017/0365141 A1
(43) Pub. Date: Dec. 21, 2017

(54) Home Security System

(71) Applicant: Denise Byrd, Tustin, CA (US)

(72) Inventor: Denise Byrd, Tustin, CA (US)

(21) Appl. No.: 15/185,365

(22) Filed: Jun. 17, 2016

(51) Int. Cl. G08B 13/08; G08B 15/00; G08B 13/04

(52) U.S. Cl. CPC G08B 13/08; G08B 13/04; G08B 15/00

(57) ABSTRACT

A home security system includes a home security system that may be positioned in a home. Thus, the home security system may detect an intruder. The home security system selectively generates an alarm sequence. An alarm unit is provided and the alarm unit may be positioned in the home. The alarm unit is electrically coupled to the home security system and the alarm unit includes an array of speakers. Each of the speakers is positioned adjacent to an associated one of the motion sensors. Each of the speakers selectively emits an audible alarm when the home security system generates the alarm sequence. Each of the speakers selectively emits the audible alarm when the associated motion sensor detects motion. Thus, each of the speakers creates the illusion of the audible alarm following the intruder through the home.

### BACKGROUND OF THE DISCLOSURE

### Field of the Disclosure

The disclosure relates to security devices and more particularly pertains to a new security device for inhibiting an intruder from entering a home.

### SUMMARY OF THE DISCLOSURE

An embodiment of the disclosure meets the needs presented above by generally comprising a home security system that may be positioned in a home. Thus, the home security system may detect an intruder. The home security system selectively generates an alarm sequence. An alarm unit is provided and the alarm unit may be positioned in the home. The alarm unit is electrically coupled to the home security system and the alarm unit includes an array of speakers. Each of the speakers is positioned adjacent to an associated one of the motion sensors. Each of the speakers selectively emits an audible alarm when the home security system generates the alarm sequence. Each of the speakers selectively emits the audible alarm when the associated motion sensor detects motion. Thus, each of the speakers creates the illusion of the audible alarm following the intruder through the home.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an alternative embodiment of a home security system according to an embodiment of the disclosure.

FIG. 2 is a front view of an alternative embodiment of the disclosure.

FIG. 3 is a back view of an alternative embodiment of the disclosure.

FIG. 4 is a right side phantom view of an alternative embodiment of the disclosure.

FIG. 5 is a schematic view of an embodiment of the disclosure.

FIG. 6 is a perspective view of an embodiment of the disclosure.

### DESCRIPTION OF THE PREFERRED EMBODIMENT

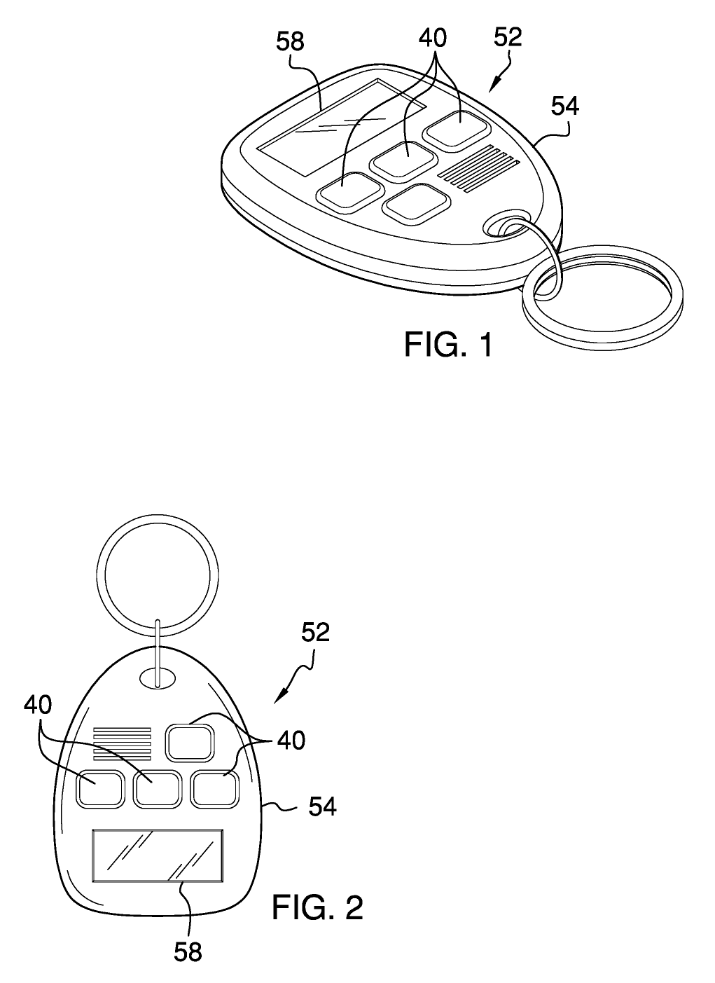

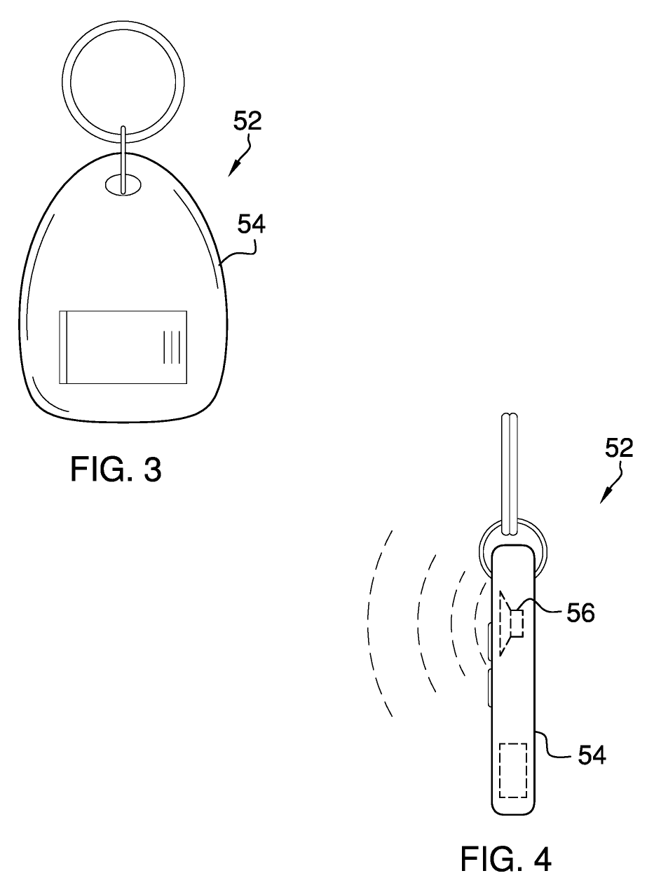

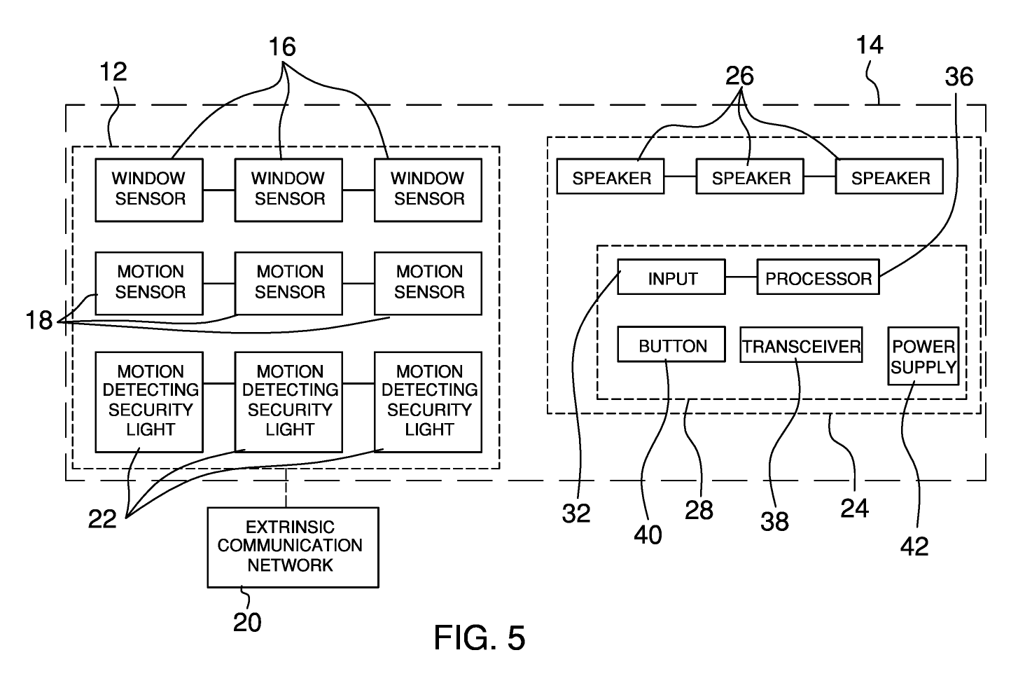

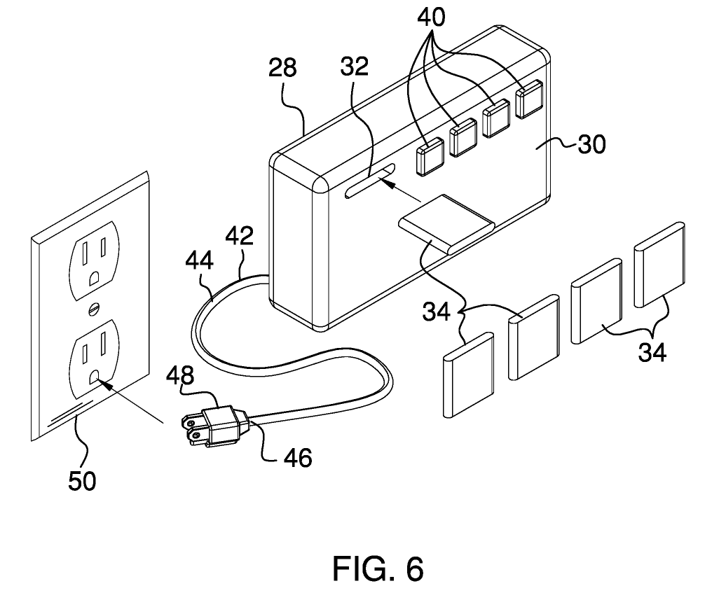

With reference now to the drawings, and in particular to FIGS. 1 through 6 thereof, a new security device embodying the principles and concepts of an embodiment of the disclosure and generally designated by the reference numeral 10 will be described.

As best illustrated in FIGS. 1 through 6, the home security system 10 generally comprises a home security system 12 that may be positioned in a home 14. Thus, the home security system 12 may detect an intruder. The home security system 12 selectively generates an alarm sequence. The home security system 12 may be an electronic home security system 12 or the like. The home 14 may be a residence, a hotel room or a college dorm room.

The home security system 12 comprises an array of window sensors 16. Each of the window sensors 16 is electrically integrated into the home security system 12. Each of the window sensors 16 may be positioned adjacent to an associated one of a plurality of windows in the home 14. Thus, each of the window sensors 16 may detect when the associated window is open or broken. The home security system 12 generates the alarm sequence when the array of window sensors 16 detects a window has been broken or opened. Each of the window sensors 16 may be an electronic window sensor or the like.

The home security system 12 includes an array of motion sensors 18. Each of the motion sensors 18 is electrically integrated into the home security system 12. The motion sensors 18 are spaced apart from each other and are distributed around the home 14. Thus, each of the motion sensors 18 may detect motion of an intruder in a corresponding area of the home 14. The home security system 12 generates the alarm sequence when the array of motion sensors 18 detects motion. Each of the motion sensors 18 may comprise an infra-red motion sensor or the like.

The home security system 12 may be in electrical communication with an extrinsic communication network 20. The home security system 12 may contact emergency responders when the home security system 12 generates the alarm sequence. The emergency responders may be local law enforcement or the like. The extrinsic communication network 20 may be a telephone network or the like.

The home security system 12 may include a plurality of motion detecting security lights 22. Each of the motion detecting security lights 22 may be attached to an outside of the home 14. Moreover, each of the motion detecting security lights 22 may be electrically integrated into the home security system 12. Each of the motion detecting security lights 22 may include an infra-red motion sensor or the like.

An alarm unit 24 is provided and the alarm unit 24 may be positioned in the home 14. The alarm unit 24 is electrically coupled to the home security system 12. The alarm unit 24 includes an array of speakers 26. Each of the speakers 26 is positioned adjacent to an associated one of the motion sensors 18. Each of the speakers 26 selectively emits an audible alarm when the home security system 12 generates the alarm sequence. Moreover, each of the speakers 26 may be positioned adjacent to doors and windows of the home 14.

The audible alarm may be the sound of a dog barking. Each of the speakers 26 selectively emits the audible alarm when the associated motion sensor 18 detects motion. Thus, each of the speakers 26 may create the illusion of a dog following the intruder through the home 14. Each of the speakers 26 may comprise a wireless electronic speaker or the like.

The alarm unit 24 comprises a housing 28 that may be positioned in the home 14. The housing 28 has a front wall 30 and an input 32 is coupled to the front wall 30. The input 32 may comprise a data card reader or the like. A plurality of electronic storage units 34 is provided. Each of the electronic storage units 34 stores data pertaining to the audible alarm. A selected one of the electronic storage units 34 is electrically coupled to the input 32. Each of the electronic storage units 34 may comprise a data card or the like.

A processor 36 is provided and the processor 36 is positioned within the housing 28. The processor 36 is electrically coupled to the home security system 12, the input 32 and each of the speakers 26. The processor 36 sequentially actuates the speakers 26 corresponding to the motion sensors 18 that detects motion when the home security system 12 generates the alarm sequence. The processor 36 may comprise an electronic processor 36 or the like.

A transceiver 38 may be provided and the transceiver 38 may be positioned in the housing 28. The transceiver 38 may be electrically coupled to the processor 36. The transceiver 38 may be in wireless communication with each of the speakers 26. Thus, the transceiver 38 may communicate with alarm sequence to each of the speakers 26. The transceiver 38 may be a radio frequency transceiver 38 with an operational frequency of three hundred fifteen MHz.

A plurality of buttons 40 is provided. Each of the buttons 40 is coupled to the housing 28 and each of the buttons 40 may be manipulated. Each of the buttons 40 is electrically coupled to the processor 36. Each of the buttons 40 controls operational parameters of the alarm unit 24.

A power supply 42 is coupled to the housing 28 and the power supply 42 is electrically coupled to the processor 36. The power supply 42 comprises a power cord 44 extending outwardly from the housing 28. The power cord 44 has a distal end 46 with respect to the housing 28. A plug 48 is electrically coupled to the distal end 46. The plug 48 may be electrically coupled to a power source 50. The power source 50 may comprise an electrical outlet or the like.

In an alternative embodiment 52 as shown in FIGS. 1 through 4, the alarm unit 24 may comprise a key fob 54 or the like. The key fob 54 may be carried and worn. The processor 36, the transceiver 38, the buttons 40 and the power supply 42 may be positioned in the key fob 54. A remote speaker 56 may be coupled to the key fob 54. The remote speaker 56 may selectively emit the audible alarm thereby deterring an attacker. A display 58 may be coupled to the key fob 54 and the display 58 may be electrically coupled to the processor 36. Thus, the display 58 may display 58 operational parameters of the alarm unit 24.

In use, the alarm unit 24 is installed in the home 14 and the alarm unit 24 is placed in electrical communication with the home security system 12. The alarm unit 24 actuates a speaker 26 to emit the audible alarm that corresponds to a window sensor 16 that has been tripped. Thus, the intruder hears the sound of a barking dog when the intruder breaks or opens a selected window. The alarm unit 24 actuates a speaker 26 to emit the audible alarm that corresponds to a motion sensor 18 that detects motion. Thus, the intruder hears the sound of a barking dog that follows the intruder through the home 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A home security system being configured to inhibit an intruder from entering a home, said system comprising:
a home security system being configured to be positioned in a home thereby facilitating said home security system to detect an intruder, said home security system selectively generating an alarm sequence; and
an alarm unit being configured to be positioned in the home, said alarm unit being electrically coupled to said home security system, said alarm unit including an array of speakers, each of said speakers being positioned adjacent to an associated one of said motion sensors, each of said speakers selectively emitting an audible alarm when said home security system generates said alarm sequence, each of said speakers selectively emitting said audible alarm when said associated motion sensor detects motion wherein each of said speakers is configured to create the illusion of said audible alarm following the intruder through the home.

2. The system according to claim 1, wherein said home security system comprises an array of window sensors, each of said window sensors being electrically integrated into said home security system, each of said window sensors being configured to be positioned adjacent to an associated one of a plurality of windows in the home thereby facilitating each of said window sensors to detect when the associated window is open or broken, said home security system generating said alarm sequence when said array of window sensors detects a window has been broken or opened.

3. The system according to claim 1, further comprising an array of motion sensors, each of said motion sensors being electrically integrated into said home security system, said motion sensors being spaced apart from each other and distributed around the home wherein each of said motion sensors is configured to detect motion of an intruder in a corresponding area of the home, said home security system generating said alarm sequence when said array of motion sensors detects motion.

4. The system according to claim 1, wherein said alarm unit comprises:
a housing being configured to be positioned in the home, said housing having a front wall;
an input being coupled to said front wall; and
a plurality of electronic storage units, each of said electronic storage units being configured to store data pertaining to an audible alarm, a selected one of said electronic storage units being electrically coupled to said input.

5. The system according to claim 4, further comprising:
an array of motion sensors; and
a processor being positioned within said housing, said processor being electrically coupled to said home security system, said input and each of said speakers, said processor sequentially actuating said speakers corresponding to said motion sensors that detects motion when said home security system generates said alarm sequence.

6. The system according to claim 5, further comprising a plurality of buttons, each of said buttons being coupled to said housing wherein each of said buttons is configured to be manipulated, each of said buttons being electrically coupled to said processor, each of said buttons controlling operational parameters of said alarm unit.

7. The system according to claim 5, further comprising a power supply being coupled to said housing, said power supply being electrically coupled to said processor, said power supply comprising a power cord extending outwardly from said housing, said power cord having a distal end with respect to said housing, said distal end having a plug being electrically coupled thereto, said plug being configured to be electrically coupled to a power source.

8. A home security system being configured to inhibit an intruder from entering a home, said system comprising:
a home security system being configured to be positioned in a home thereby facilitating said home security system to detect an intruder, said home security system selectively generating an alarm sequence, said home security system comprising:
an array of window sensors, each of said window sensors being electrically integrated into said home security system, each of said window sensors being configured to be positioned adjacent to an associated one of a plurality of windows in the home thereby facilitating each of said window sensors to detect when the associated window is open or broken, said home security system generating said alarm sequence when said array of window sensors detects a window has been broken or opened, and
an array of motion sensors, each of said motion sensors being electrically integrated into said home security system, said motion sensors being spaced apart from each other and distributed around the home wherein each of said motion sensors is configured to detect motion of an intruder in a corresponding area of the home, said home security system generating said alarm sequence when said array of motion sensors detects motion; and
an alarm unit being configured to be positioned in the home, said alarm unit being electrically coupled to said home security system, said alarm unit including an array of speakers, each of said speakers being positioned adjacent to an associated one of said motion sensors, each of said speakers selectively emitting an audible alarm when said home security system generates said alarm sequence, each of said speakers selectively emitting said audible alarm when said associated motion sensor detects motion wherein each of said speakers is configured to create the illusion of said audible alarm following the intruder through the home, said alarm unit comprising:
a housing being configured to be positioned in the home, said housing having a front wall,
an input being coupled to said front wall,
a plurality of electronic storage units, each of said electronic storage units being configured to store data pertaining to an audible alarm, a selected one of said electronic storage units being electrically coupled to said input,
a processor being positioned within said housing, said processor being electrically coupled to said home security system, said input and each of said speakers, said processor sequentially actuating said speakers corresponding to said motion sensors that detects motion when said home security system generates said alarm sequence,
a plurality of buttons, each of said buttons being coupled to said housing wherein each of said buttons is configured to be manipulated, each of said buttons being electrically coupled to said processor, each of said buttons controlling operational parameters of said alarm unit, and
a power supply being coupled to said housing, said power supply being electrically coupled to said processor, said power supply comprising a power cord extending outwardly from said housing, said power cord having a distal end with respect to said housing, said distal end having a plug being electrically coupled thereto, said plug being configured to be electrically coupled to a power source.
